(19) United States
(12) Patent Application Publication
(10) Pub. No.: US 2010/0073964 A1
(43) Pub. Date: Mar. 25, 2010

(54) SWITCHING CONTROL CIRCUIT AND SWITCHING POWER SUPPLY

(76) Inventors: Naohisa TATSUKAWA, Osaka (JP); Satoru Takahashi, Shiga (JP); Yoshiaki Hachiya, Shiga (JP)

Correspondence Address: MCDERMOTT WILL & EMERY LLP, 600 13TH STREET, NW, WASHINGTON, DC, 20005-3096, US

(21) Appl. No.: 12/486,406

(22) Filed: Jun. 17, 2009

(30) Foreign Application Priority Data
Sep. 24, 2008 (JP) 2008-244808

(51) Int. Cl. H02M 3/22; H02M 7/04

(52) U.S. Cl. 363/15; 363/84

(57) ABSTRACT

A switching element controls supply of a primary current to a transformer in a switching power supply. An amplifier circuit amplifies an output ripple of an auxiliary winding of a transformer. A fluctuation generator circuit generates a fluctuating signal, based on an output of the amplifier circuit. A basic signal generator circuit generates a PWM basic signal whose frequency fluctuates according to the fluctuating signal. A control circuit ON controls the switching element when receiving the PWM basic signal, and OFF controls the switching element when receiving an OFF signal based on output feedback of the switching power supply.

### CROSS-REFERENCE TO RELATED APPLICATION

This application claims priority under 35 U.S.C. §119(a) on Japanese Patent Application No. 2008-244808 filed on Sep. 24, 2008, the entire contents of which are hereby incorporated by reference.

### BACKGROUND OF THE INVENTION

The present disclosure relates to a PWM (pulse width modulation) switching power supply, and more particularly relates to a switching control circuit of the PWM switching power supply.

Switching power supplies have been widely used for power converters, such as AC-DC converters, DC-DC converters and the like, for converting input power into direct current power. In general, a switching power supply performs PWM control of a switching element to repeat a supply of a primary current to a transformer and a halt of the supply, thereby converting input power to desired direct current power.

As described above, in a switching power supply, a switching element repeats switching ON/OFF without interruption. Since a switching frequency of the switching element is relatively high, the switching power supply radiates switching noise. The switching noise causes malfunction of peripheral electronic devices, and therefore, it is desired to suppress the switching noise as much as possible. To solve this EMI (electro-magnetic interference) problem, peaks of the switching noise are suppressed by causing a PWM basic frequency to fluctuate to spread the spectrum of the switching noise (see, for example, Patent Document 1).
Patent Document 1: Japanese Published Application No. 2005-295637

### SUMMARY OF THE INVENTION

There are cases where a PFC circuit is not used and an input smoothing capacitor for smoothing a rectified direct current voltage is provided at an input side of a switching power supply. In such a switching power supply, in order to cause the PWM basic frequency to fluctuate using an input ripple, a capacity value of an input smoothing capacitor has to be small. That is, the input ripple has to be large. However, when the input ripple is large, a power supply capacity of the switching power supply fluctuates at all times. In general, in the switching power supply, overcurrent protection of the switching element is performed based on feedback of an output voltage, and thus, if the power supply capacity fluctuates at all times, the overcurrent protection becomes unstable. On the other hand, if a ripple is artificially generated without using an input ripple, a ripple generator circuit is needed and thus a circuit size is increased.

In view of the above-described problems, an example switching control circuit may allow a PWM basic frequency to fluctuate without specifically manipulating an input ripple of a switching power supply.

The detailed description describes a switching control circuit for performing PWM control of a switching element which controls supply of a primary current to a transformer in a switching power supply for converting input power to direct current power, the switching control circuit including: an amplifier circuit for amplifying an output ripple of an auxiliary winding of the transformer; a fluctuation generator circuit for generating a fluctuating signal, based on an output of the amplifier circuit; a basic signal generator circuit for generating a PWM basic signal whose frequency fluctuates according to the fluctuating signal; and a control circuit for ON controlling the switching element when receiving the PWM basic signal, and OFF controlling the switching element when receiving an OFF signal based on output feedback of the switching power supply.

Moreover, the detailed description describes a switching control circuit for performing PWM control of a switching element which controls supply of a primary current to a transformer in a switching power supply for converting input power to direct current power, the switching control circuit including: a feedback circuit for receiving a detection of an output of an auxiliary winding of the transformer to generate a feedback signal; a fluctuation generator circuit for generating a fluctuating signal, based on an output ripple of the auxiliary winding amplified by the feedback circuit; a basic signal generator circuit for generating a PWM basic signal whose frequency fluctuates according to the fluctuating signal; and a control circuit for ON controlling the switching element when receiving the PWM basic signal, and OFF controlling the switching element when receiving an OFF signal generated based on the feedback signal.

Furthermore, the detailed description describes a switching power supply for converting input power to direct current power, the switching power supply including: either one of the above-described switching control circuits; a transformer; a switching element which is connected to a primary winding of the transformer and is PWM controlled by the switching control circuit; a rectifier element, connected to the auxiliary winding of the transformer, for rectifying a secondary current of the auxiliary winding; and a smoothing element for smoothing a current rectified by the rectifier element to generate a direct current voltage.

With the above-described means, it is possible to cause the PWM basic frequency to fluctuate using the output ripple of the auxiliary winding of the transformer.

Also, the detailed description describes a switching control circuit for performing PWM control of a switching element which controls supply of a primary current to a transformer in a switching power supply for converting input power to direct current power, the switching control circuit including: an amplifier circuit for amplifying an output ripple of the switching power supply; a fluctuation generator circuit for generating a fluctuating signal, based on an output of the amplifier circuit; a basic signal generator circuit for generating a PWM basic signal whose frequency fluctuates according to the fluctuating signal; and a control circuit for ON controlling the switching element when receiving the PWM basic signal, and OFF controlling the switching element when receiving an OFF signal based on output feedback of the switching power supply.

Moreover, the detailed description describes a switching control circuit for performing PWM control of a switching element which controls supply of a primary current to a transformer in a switching power supply for converting input power to direct current power, the switching control circuit including: a feedback circuit for receiving a detection of an output of the switching power supply to generate a feedback signal; a fluctuation generator circuit for generating a fluctuating signal, based on an output ripple of the switching power supply amplified by the feedback circuit; a basic signal generator circuit for generating a PWM basic signal whose frequency fluctuates according to the fluctuating signal; and a control circuit for ON controlling the switching element when receiving the PWM basic signal, and OFF controlling the switching element when receiving an OFF signal generated based on the feedback signal.

Furthermore, the detailed description describe a switching power supply for converting input power to direct current power, the switching power supply including: either one of the above-described switching control circuits; a transformer; a switching element which is connected to a primary winding of the transformer and is PWM controlled by the switching control circuit; a rectifier element, connected to a secondary winding of the transformer, for rectifying a secondary current of the transformer; and a smoothing element for smoothing a current rectified by the rectifier element to generate a direct current voltage.

With the above-described means, it is possible to cause the PWM basic frequency to fluctuate using the output ripple of the switching power supply.

### BRIEF DESCRIPTION OF THE DRAWINGS

FIG. 1 is a block diagram of a switching power supply according to a first embodiment.

FIG. 2 is a diagram illustrating an example configuration where a current detector circuit is provided at a source side of a switching element.

FIG. 3 is a diagram illustrating an example configuration of an output voltage detector circuit.

FIG. 4 is a diagram illustrating an example configuration of a feedback circuit.

FIG. 5 is a block diagram of a modified example of the switching power supply of the first embodiment.

FIG. 6 is a block diagram of a switching power supply according to a second embodiment.

FIG. 7 is a diagram illustrating an example configuration of a feedback circuit.

FIG. 8 is a block diagram of a modified example of the switching power supply of the second embodiment.

### DETAILED DESCRIPTION OF THE INVENTION

Hereinafter, best modes of the present invention will be described with reference to the accompanying drawings.

### First Embodiment

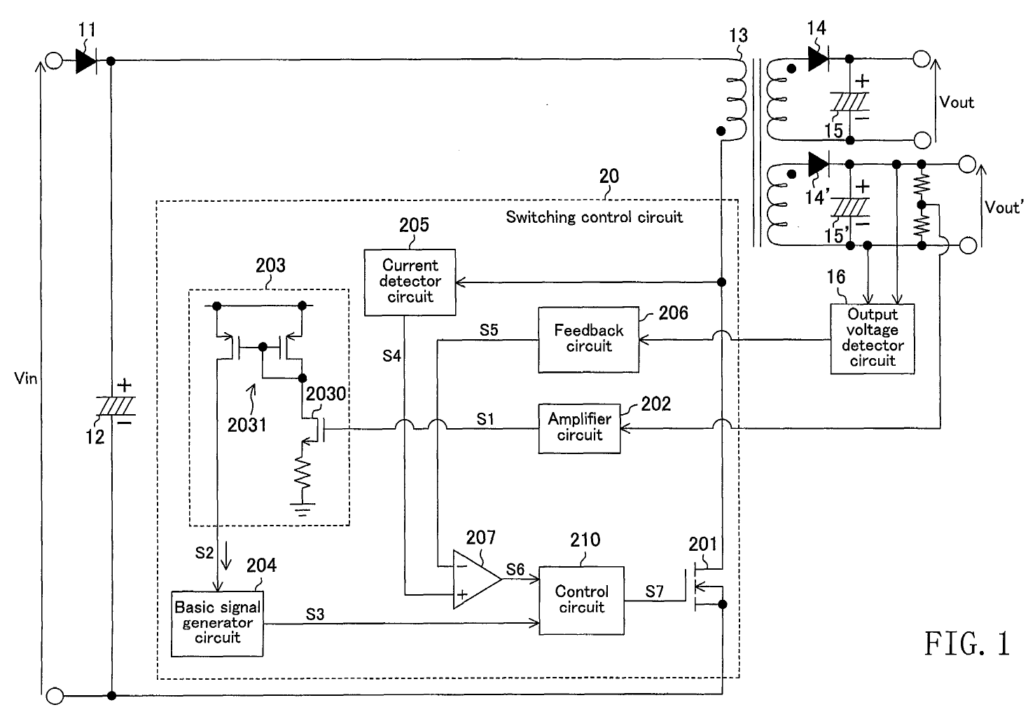

FIG. 1 is a block diagram of a switching power supply according to a first embodiment. An input rectifier diode 11 and an input smoothing capacitor 12 rectify and smooth an alternate current input Vin and supply a direct current to a primary side of a transformer 13. An output rectifier diode 14 and an output smoothing capacitor 15 rectify and smooth a secondary current of the transformer 13 and generate a direct current output Vout. An output rectifier diode 14′ and an output smoothing capacitor 15′ rectify and smooth an auxiliary winding output of the transformer 13 and generate a direct current output Vout′ having the same phase as that of the direct current Vout. A switching control circuit 20 controls supply of a primary current to the transformer 13. Specifically, the supply of the primary current to the transformer 13 is controlled by ON/OFF operation of a switching element 201 connected to a primary winding. Note that the switching control circuit 20 can be configured as a single semiconductor chip. The switching element 201 may be provided outside the switching control circuit 20.

In the switching control circuit 20, an amplifier circuit 202 amplifies an intermediate voltage of the output smoothing capacitor 15′, and outputs the signal S1. That is, the amplifier circuit 202 amplifies an output ripple of an auxiliary winding of the transformer 13. Specifically, the amplifier circuit 202 can be formed of an operational amplifier, a mirror circuit or the like. The fluctuation generator circuit 203 generates a fluctuating signal S2, based on the signal S1. Specifically, the signal S1 is input to a gate of a transistor 2030. The transistor 2030 is connected to an input side of a current mirror circuit 2031. Thus, a current which fluctuates according to the signal S1 is output from the current mirror circuit 2031. The current becomes the fluctuating signal S2. A basic signal generator circuit 204 generates a PWM basic signal S3 whose frequency fluctuates according to the fluctuating signal S2.

Note that the frequency of the fluctuating signal S2 is preferably about 10% of the PWM basic frequency even at highest setting. For example, when the PWM basic frequency is 100 kHz and the frequency of the fluctuating signal S2 is 10 kHz, the PWM basic signal S3 varies between 100 kHz and 110 kHz.

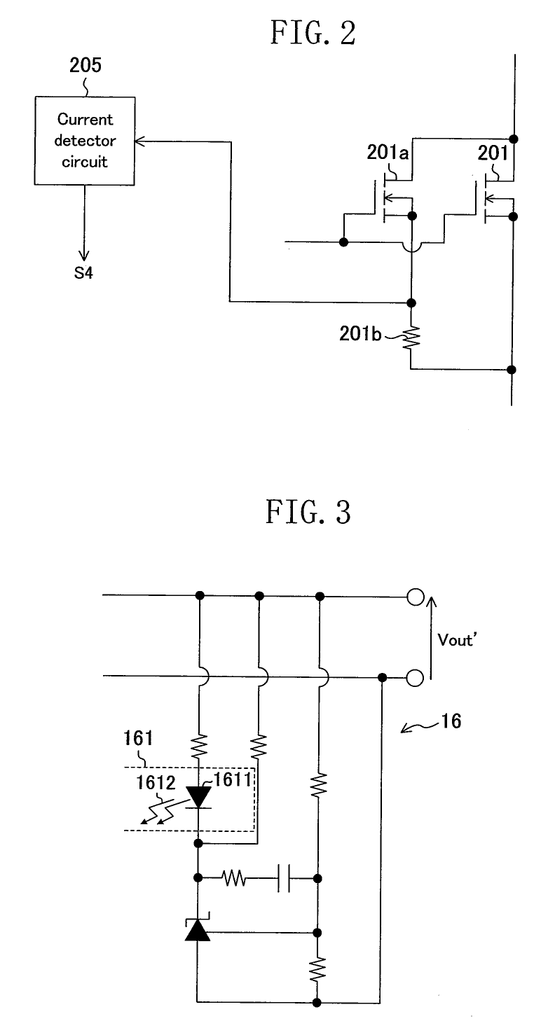

A current detector circuit 205 detects a current flowing through the switching element 201, and outputs a detection signal S4. The current detector circuit 205 may be provided at a source side of the switching element 201. FIG. 2 is a diagram illustrating an example configuration where the current detector circuit 205 is provided at the source side of the switching element 201. In this case, a sense element 201a and a sense resistor 201b for flowing a sufficiently smaller current than that of the switching element 201 are provided in parallel to the switching element 201. The current detector circuit 205 indirectly detects, from a voltage of the sense resistor 201b, a current flowing through the switching element 201.

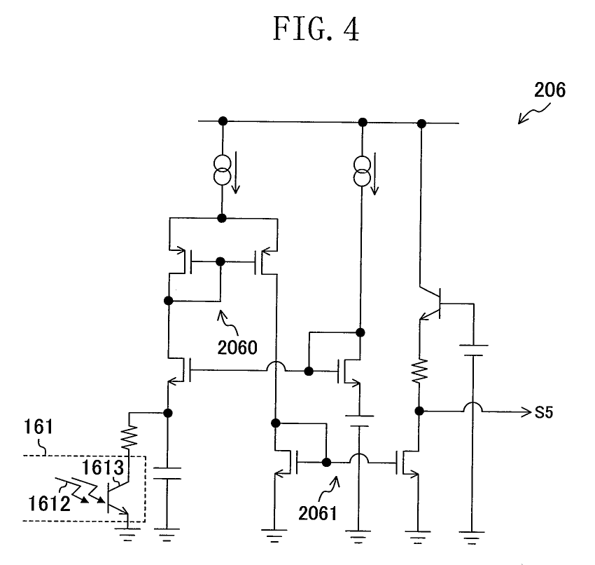

Returning to FIG. 1, a feedback circuit 206 generates a feedback signal S5 which is to be a target value of the detection signal S4, based on the direct current output Vout′ detected by an output voltage detector circuit 16. FIG. 3 and FIG. 4 illustrate an example configuration of the output voltage detector circuit 16 and an example configuration of the feedback circuit 206, respectively. A light emitting diode 1611 of a photocoupler 161 outputs light 1612 at a light intensity corresponding to the direct current output Vout′. A photo transistor 1613 of the photocoupler 161 receives the light 1612. A current flowing through the photo transistor 1613 is converted to the feedback signal S5 via current mirror circuits 2060 and 2061.

Returning to FIG. 1, a comparator 207 compares the detection signal S4 to the feedback signal S5 and, when the detection signal S4 reaches the feedback signal S5, the comparator 207 outputs an OFF signal S6. The control circuit 210 ON controls the switching element 201 when receiving the PWM basic signal S3, and OFF controls the switching element 201 when receiving the OFF signal S6. Specifically, the control circuit 210 can be formed of an SR latch circuit which is set by the PWM basic signal S3, is reset by the OFF signal S6, and outputs the signal S7. Once receiving the PWM basic signal S3, the control circuit 210 continuously ON controls the switching element 201 until the control circuit 210 receives the OFF signal S6, whether or not the PWM basic signal S3 is input.

As described above, according to this embodiment, it is possible to cause the PWM basic frequency to fluctuate using the output ripple of the auxiliary winding of the transformer 13. The auxiliary winding is provided solely for the purpose of feedback control of the switching power supply, and thus a capacity value of the output smoothing capacitor 15′ can be freely changed without affecting the direct current output Vout. Therefore, peaks of switching noise can be reduced by fluctuating the PWM basic frequency without specifically manipulating the input ripple.

Note that the alternate current input Vin may be full wave rectified using a diode bridge, instead of the input rectifier diode 11.

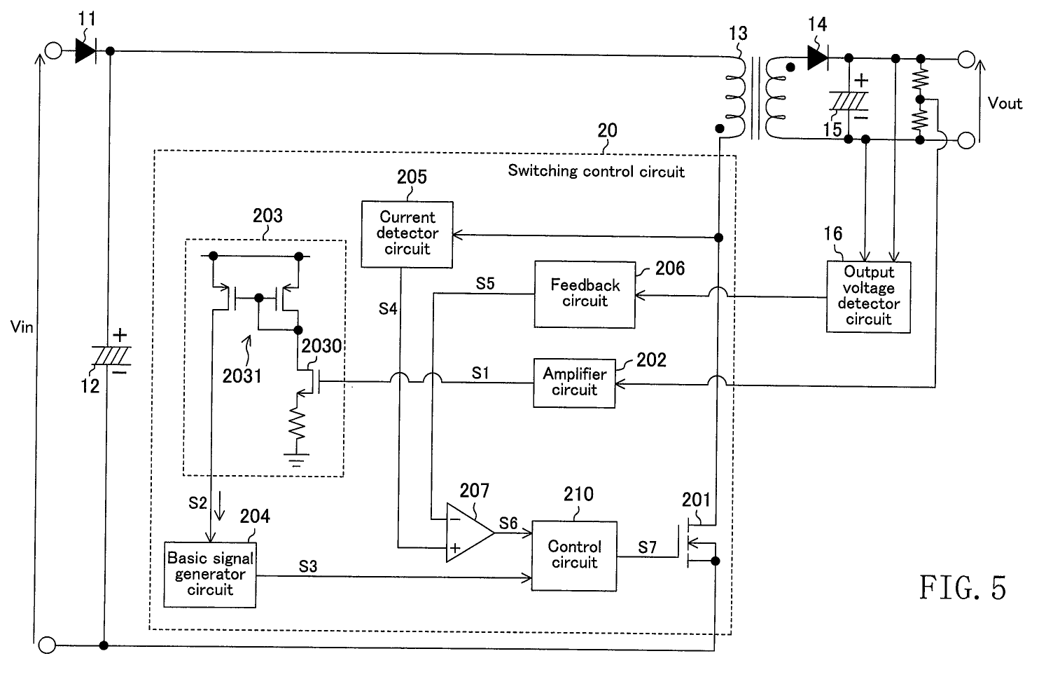

When the transformer 13 does not include an auxiliary winding, the output voltage detector circuit 16 may be configured to detect a direct current output Vout. FIG. 5 is a block diagram of a modified example of the switching power supply of this embodiment. Even in this case, peaks of switching noise can be reduced by fluctuating the PWM basic frequency without specifically manipulating the input ripple.

### Second Embodiment

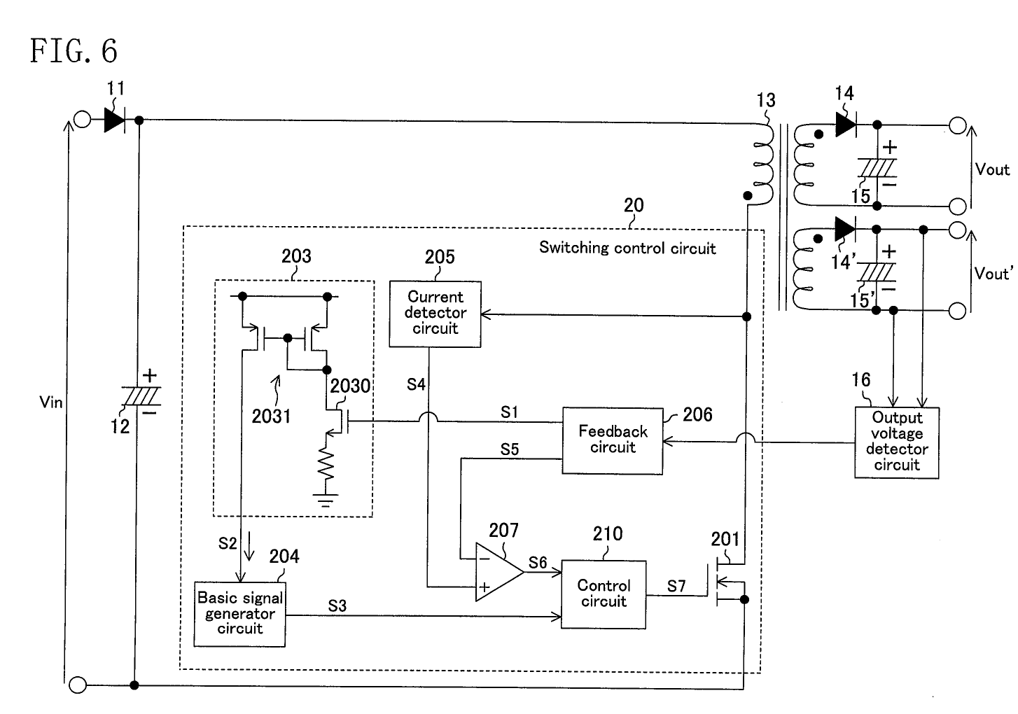

FIG. 6 is a block diagram of a switching power supply according to a second embodiment. The switching power supply of this embodiment is configured by omitting the amplifier circuit 202 of the switching power supply of the first embodiment, so that the signal S1 is supplied from the feedback circuit 206 to the fluctuation generator circuit 203. Hereinafter, only different points from the first embodiment will be described.

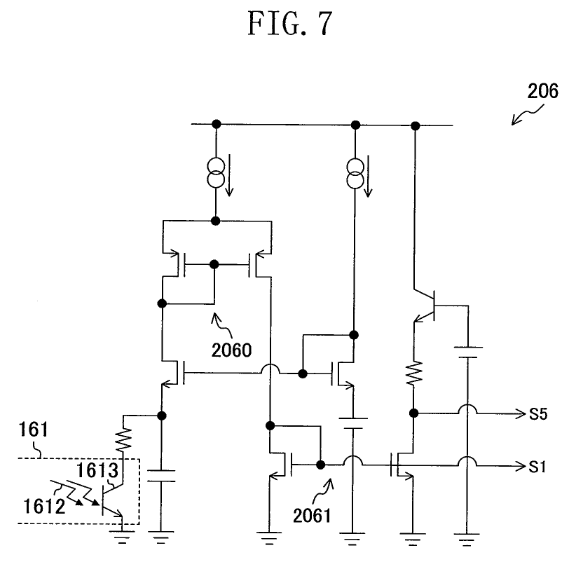

The feedback circuit 206 amplifies an output ripple in the course of generating the feedback signal S5. Therefore, an internal signal of the feedback circuit 206 can be supplied as the signal S1 to the fluctuation generator circuit 203. FIG. 7 is a diagram illustrating an example configuration of the feedback circuit 206. The feedback circuit 206 has exactly the same configuration as that shown in FIG. 4. In this case, a gate voltage of a current mirror circuit 2061 can be used as the signal S1. Thus, according to this embodiment, it is not necessary to additionally provide a circuit for generating the signal S1 based on which the fluctuating signal S2 is generated, and, therefore, a circuit size of the switching power supply can be made smaller than that of the first embodiment.

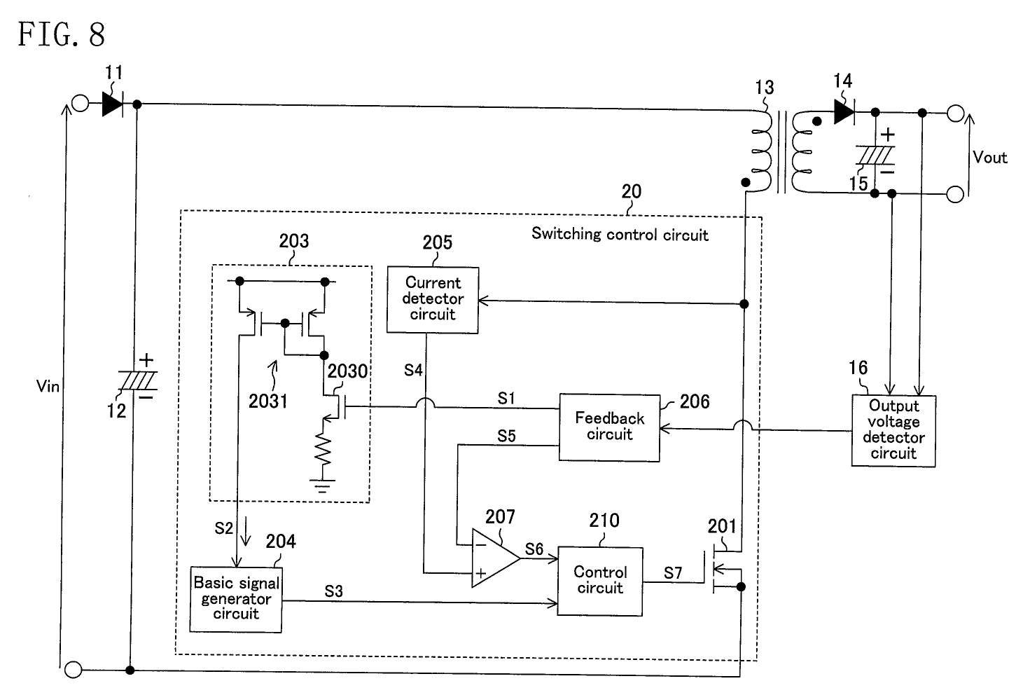

When the transformer 13 does not include an auxiliary winding, the output voltage detector circuit 16 may be configured to detect a direct current output Vout. FIG. 8 is a block diagram of a modified example of the switching power supply of this embodiment. Even in this case, peaks of switching noise can be reduced by fluctuating the PWM basic frequency without specifically manipulating the input ripple.

What is claimed is:

1. A switching control circuit for performing PWM control of a switching element which controls supply of a primary current to a transformer in a switching power supply for converting input power to direct current power, the switching control circuit comprising:
an amplifier circuit for amplifying an output ripple of an auxiliary winding of the transformer;
a fluctuation generator circuit for generating a fluctuating signal, based on an output of the amplifier circuit;
a basic signal generator circuit for generating a PWM basic signal whose frequency fluctuates according to the fluctuating signal; and
a control circuit for ON controlling the switching element when receiving the PWM basic signal, and OFF controlling the switching element when receiving an OFF signal based on output feedback of the switching power supply.

2. A switching control circuit for performing PWM control of a switching element which controls supply of a primary current to a transformer in a switching power supply for converting input power to direct current power, the switching control circuit comprising:
a feedback circuit for receiving a detection of an output of an auxiliary winding of the transformer to generate a feedback signal;
a fluctuation generator circuit for generating a fluctuating signal, based on an output ripple of the auxiliary winding amplified by the feedback circuit;
a basic signal generator circuit for generating a PWM basic signal whose frequency fluctuates according to the fluctuating signal; and
a control circuit for ON controlling the switching element when receiving the PWM basic signal, and OFF controlling the switching element when receiving an OFF signal generated based on the feedback signal.

3. A switching control circuit for performing PWM control of a switching element which controls supply of a primary current to a transformer in a switching power supply for converting input power to direct current power, the switching control circuit comprising:
an amplifier circuit for amplifying an output ripple of the switching power supply;
a fluctuation generator circuit for generating a fluctuating signal, based on an output of the amplifier circuit;
a basic signal generator circuit for generating a PWM basic signal whose frequency fluctuates according to the fluctuating signal; and
a control circuit for ON controlling the switching element when receiving the PWM basic signal, and OFF controlling the switching element when receiving an OFF signal based on output feedback of the switching power supply.

4. A switching control circuit for performing PWM control of a switching element which controls supply of a primary current to a transformer in a switching power supply for converting input power to direct current power, the switching control circuit comprising:
a feedback circuit for receiving a detection of an output of the switching power supply to generate a feedback signal;
a fluctuation generator circuit for generating a fluctuating signal, based on an output ripple of the switching power supply amplified by the feedback circuit;
a basic signal generator circuit for generating a PWM basic signal whose frequency fluctuates according to the fluctuating signal; and
a control circuit for ON controlling the switching element when receiving the PWM basic signal, and OFF controlling the switching element when receiving an OFF signal generated based on the feedback signal.

5. A switching power supply for converting input power to direct current power, the switching power supply comprising:
the switching control circuit of claim 1;
a transformer;
a switching element which is connected to a primary winding of the transformer and is PWM controlled by the switching control circuit;
a rectifier element, connected to the auxiliary winding of the transformer, for rectifying a secondary current of the auxiliary winding; and
a smoothing element for smoothing a current rectified by the rectifier element to generate a direct current voltage.

6. A switching power supply for converting input power to direct current power, the switching power supply comprising:
the switching control circuit of claim 2;
a transformer;
a switching element which is connected to a primary winding of the transformer and is PWM controlled by the switching control circuit;
a rectifier element, connected to the auxiliary winding of the transformer, for rectifying a secondary current of the auxiliary winding; and
a smoothing element for smoothing a current rectified by the rectifier element to generate a direct current voltage.

7. A switching power supply for converting input power to direct current power, the switching power supply comprising:
the switching control circuit of claim 3;
a transformer;
a switching element which is connected to a primary winding of the transformer and is PWM controlled by the switching control circuit;
a rectifier element, connected to a secondary winding of the transformer, for rectifying a secondary current of the transformer; and
a smoothing element for smoothing a current rectified by the rectifier element to generate a direct current voltage.

8. A switching power supply for converting input power to direct current power, the switching power supply comprising:
the switching control circuit of claim 4;
a transformer;
a switching element which is connected to a primary winding of the transformer and is PWM controlled by the switching control circuit;
a rectifier element, connected to a secondary winding of the transformer, for rectifying a secondary current of the transformer; and
a smoothing element for smoothing a current rectified by the rectifier element to generate a direct current voltage.
